(19) United States
(12) Patent Application Publication
(10) Pub. No.: US 2010/0139784 A1
(43) Pub. Date: Jun. 10, 2010

(54) FLOAT-CONTROLLED WATER INFLOW SWITCHING DEVICE FOR WATER PUMP

(76) Inventor: I-JEN HUANG, Wu Fong Hsiang (TW)

Correspondence Address: LEONG C LEI, PMB # 1008, 1867 YGNACIO VALLEY ROAD, WALNUT CREEK, CA, 94598, US

(21) Appl. No.: 12/329,645

(22) Filed: Dec. 8, 2008

(51) Int. Cl. F16K 31/18

(52) U.S. Cl. 137/409

(57) ABSTRACT

A float-controlled water inflow switching device is provided for use with a water pump for pressurizing tap water and functions to safely collect and re-use of water drainage from the pump and associated piping for pressure relief purposes. The switching device includes a container arranged in water supply piping of the pump and forming a water return port connected to a water return pipe from the pump. The container includes a float arranged therein to selectively close/open a tap water supply port and has a water outlet port connected to the water in-feed end of the pump to directly supply tap water to the pump or to alternatively supply water contained in the container to the pump by means of automatic switching realized by closing the tap water supply port by the movement of the float at the time when the water inside the container reaches a preset water level.

### TECHNICAL FIELD OF THE INVENTION

The present invention relates generally to a float-controlled water inflow switching device for a water pump, which comprises an improved structure for switching between water sources for pressurization by the pump and reuse of water drainage from the pump and has a container mounted to a water in-feed end of the pump for operation to open/close a water supply port by means of a float in accordance with water level inside the container that buoys the float for receiving and supplying an external tap water source for pressurization by the pump so as to realize automatic switching between the tap water and an internal water source contained in the container, allowing water drainage from the pump occurring when pressurization by the pump is interrupted to be quickly released from the pump and collected in the container to serve as the internal water source for reuse in the subsequent operations of the pump, whereby the water inflow for pressurization by the pump is automatically switchable to meet the needs for environment protection, safe, and economics.

### DESCRIPTION OF THE PRIOR ART

Water supply piping systems for regular pressurized spraying often uses tap water or water from a reservoir as a water source for operation of a water pump. When the supply of pressurized water from the pump is interrupted or blocked, due to the high internal pressure of the piping system, leakage often occurs at terminals of the water conveyance pipes. Thus, water/pressure relief valve is mounted to the water conveyance pipe to timely release the high internal pressure (and thus the pressurized water) of the pipe. The release of the pressurized water from the pump or pipes at the time when the pump is shut down or the discharge end of the water conveyance pipe is closed is often to directly discharge or drain the pressurized water to the surroundings, perhaps through certain pipe connection. Releasing or draining the undesired pressurized water in this way may cause contamination to the environment, which is of a severe concern for the modern society that puts substantial attention to sanitation and environmental protection. Even when the water is drained to the city sewage system, it may be disadvantageous in consideration of waste of water resources. Thus, it is now a serious problem of how to collect and safely store such pressurized water drainage from the pump and associated piping system and re-use such drained water in order to ensure integrity of the existing water supply system and sanitation and safe of water use and effective recycling and repeated use of the water drainage. Especially for the advanced countries, where the water supply is often obtained from tap water systems, the recycle of water resources and supply of the recycled water for operation of pumps must be further improved to integrate with the current pump-based water supply system in order to achieve the goals of saving water and simplifying installation, and also eliminating the concerns about problems associated with environment, sanitation, and operation safety of high pressure operation of water by pumps.

### SUMMARY OF THE INVENTION

The present invention aims to solve the above discussed problems of environmental protection and operation safety associated with piping pressure relief and water drainage and provides a float-controlled water inflow switching device that is operated under the control of a float to selectively close a water supply port that receives a tap water source and switch the pump to another water source for operation safety of water supplying, which, together with collection and reuse of drainage of pressurized water, realizes automatic switching of water inflows to the pump and quick relief of pipe internal pressure to ensure safe operation and thus effectively eliminating the problems associated with environmental protection and use caused by the operation and water drainage of pressurization pump.

An objective of the present invention is to directly mount a water container to a water pump for convenient collection of the water drainage from high pressure piping system of the pump and use a float based switching device to control opening/closing of a tap water supply port for realizing automatic switching of water sources that are supplied to the pump for pressurization and out-feeding, whereby automatic switching can be safety performed, which together with collection and reuse of the drained water, allows the pressurization and out-feeding of water by the pump to be operated in a safe, sanitary, and economic manner.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a water container constructed in accordance with the present invention for supplying water to a water pump.

FIG. 2 is a perspective of the water container in accordance with the present invention.

FIG. 3 is a cross-sectional view of the water container illustrating supplying of tap water that serves as an external water source to the water pump.

FIG. 4 is an enlarged view of a portion of FIG. 3 to illustrate supplying of tap water to the water pump.

FIG. 5 is a cross-sectional view illustrating returning of water drainage from the pump back to the water container after the pump is shut down.

FIG. 6 is a cross-sectional view of the water container illustrating supplying of water from the container, which serves as an internal water source, to the water pump.

FIG. 7 is an enlarged view of a portion of FIG. 6 to illustrate supplying of the water from the container to the water pump.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

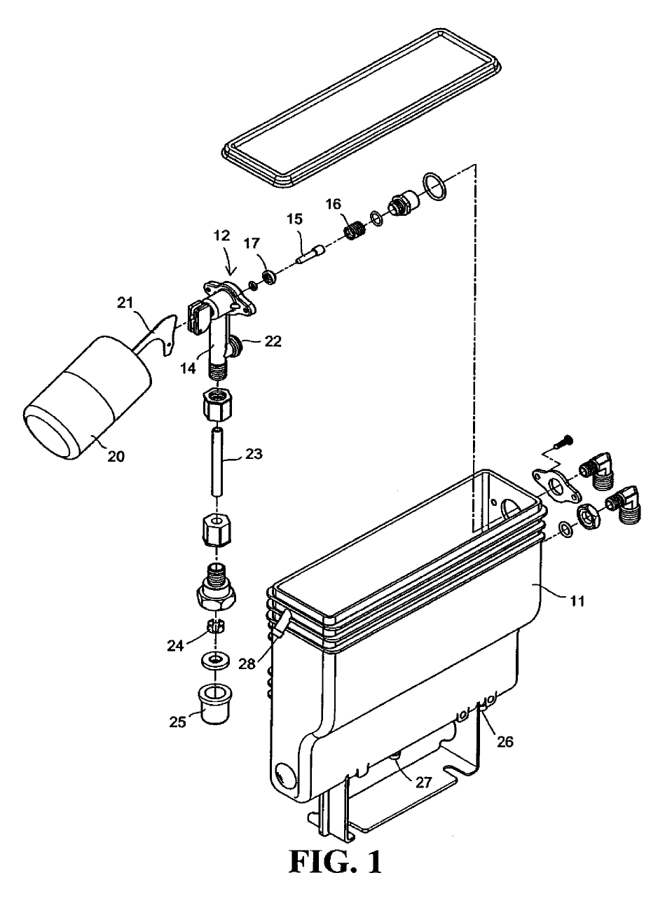

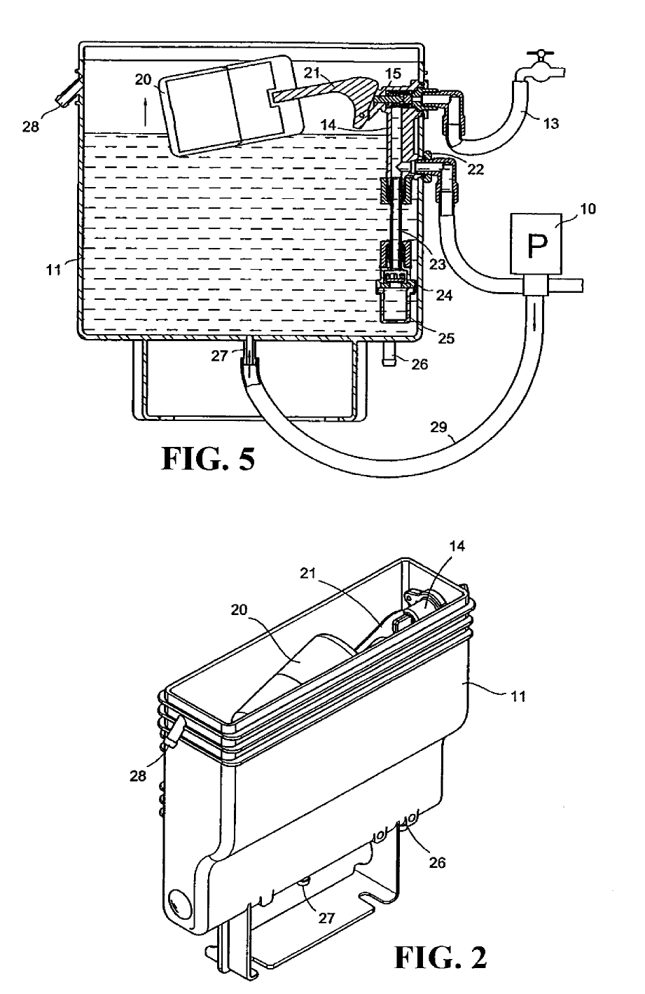

The present invention provides a float-controlled water inflow switching device for a water pump that uses tap water as an external water supply source and the switching device functions to realize efficient collection of water that drains from the pump for pressure relief purposes and to perform automatic switching of water inflow from tap water to the water collected in the container on the basis of accumulation of collected water reaching a preset threshold or water level of water storage. The float-controlled water inflow switching device of the present invention will be explained with reference to the drawings, and particularly to FIGS. 1-7. The float-controlled water inflow switching device comprises a water container 11 that is coupled to a water in-feed end of a water pump 10. Inside the container 11, a water supply port 12 is formed in a wall of an upper portion of the water container 11 for connection with a supply conduit 13 of tap water that serves as an external water source. Interior of the water supply port 12 is in fluid communication with interior of the water container 11 through a T-shaped coupling tube 14 extending and in communication with a lower portion of the interior of the water container 11. The coupling tube 14 has a top end pipe that is in fluid communication with the water supply port 12 and movably and substantially coaxially receives therein a plug bar 15. The coupling tube 14 also contains in the top end thereof a resilient element 16 that is preferably a helical spring arranged to surround the plug bar 15 for applying a force to a seal ring 17, which seals the coupling tube 14 against the plug bar 15 that extends out of the coupling tube 14 to have an end thereof coupled to an operation arm 21 extending from a float 20. When the float 20 floats up and down with the variation of the water level inside the water container 11, the operation arm 21 swings and causes the plug bar 15 to do sliding motion for extension/retraction to effect sealing engagement with/disengagement from and thus blocking/opening an inner opening of the water supply port 12 thereby selectively shutting off inflow of tap water into the coupling tube 14. A water outlet port 22 is formed in preferably a middle section of the coupling tube 14 for connection with the water pump 10 to provide a complete water supply loop of the water pump 10. The coupling tube 14 forms at a lower end thereof an extension pipe 23 that extends to a location close to a bottom of the lower portion of the water container 11. The extension pipe 23 comprises a check valve 24 that is of a simple construction comprising an up-and-down movable disk for closing a top opening of a filter can 25 coupled to the lower end of the extension pipe 23 whereby a unidirectional inflow of water from the water container 11 into the coupling tube 14 is selectively formed. Due to filtering water carried out by the filter can 25 and the unidirectional operability of the disk check valve 24, when the water accumulated inside the water container 11 reaches a preset threshold defined by a given water level, the float 20 floats upward to reach a corresponding position where the float 20 makes the plug bar 15 sliding to close or block the inner opening of the tap water supply port 12, thereby shutting off the supply of tap water, so that when the pump 10 is actuated again, the water accumulated in the waters container 11, which serves as an internal water source, is drawn through and subjected to filtering by the filter can 25 to cause the disk check valve 24 to move upward and thus open, allowing water to supply from the interior of the water container 11 to the water pump 10. In this way, automatic switching of water inflows to the water pump 10 is realized.

The water container 11 forms in the bottom thereof a water drain port 26 for draining water to clean the water container 11 and a water return port 27 for receiving water drainage from the water pump 10 and associated piping connection. The water container 11 also forms a vent hole 28 in a wall of the top portion thereof for air ventilation to realize pressure balance of the interior of the water container 11. The water pump 10 is connected via a water return tube 29 to the water return port 27 for easy and safe collection of the water drainage, which is released from the pump and associated piping, inside the water container 11, whereby water supply and water returning are both completed with a closed pipe/tube loop for ensuring environmental protection and sanitation and water pressurization. Thus, the pressurization and supply of water and the relief of water from the pump 10 form a complete connection and system for water supply, realizing a complete water flow piping system for pressurization and supply of water by the pump 10 and making the operation and water pressurization of the pump 10 completely sanitary.

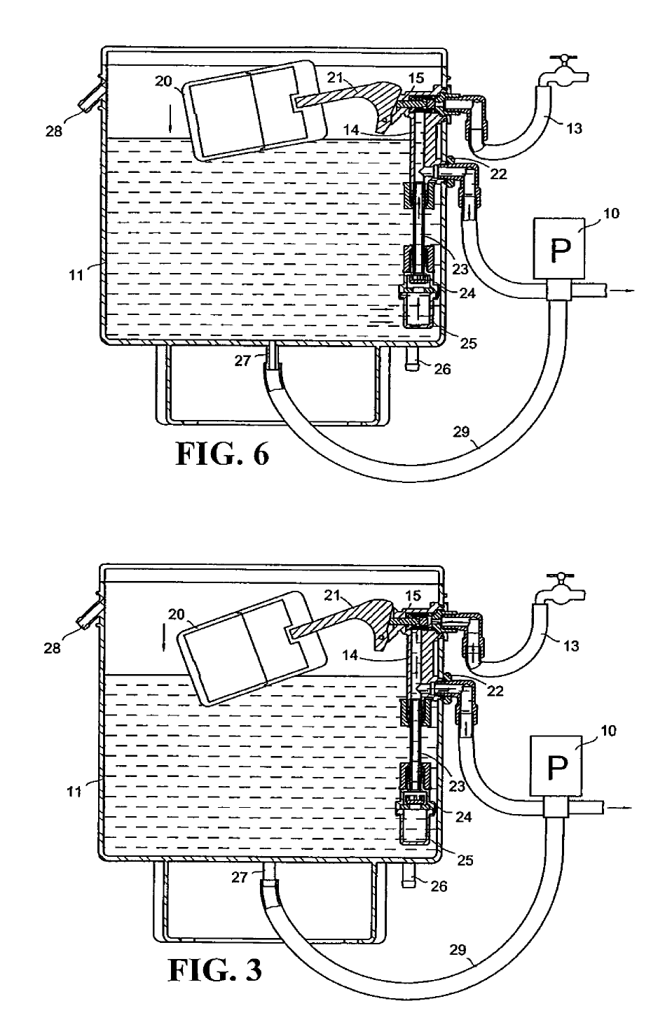

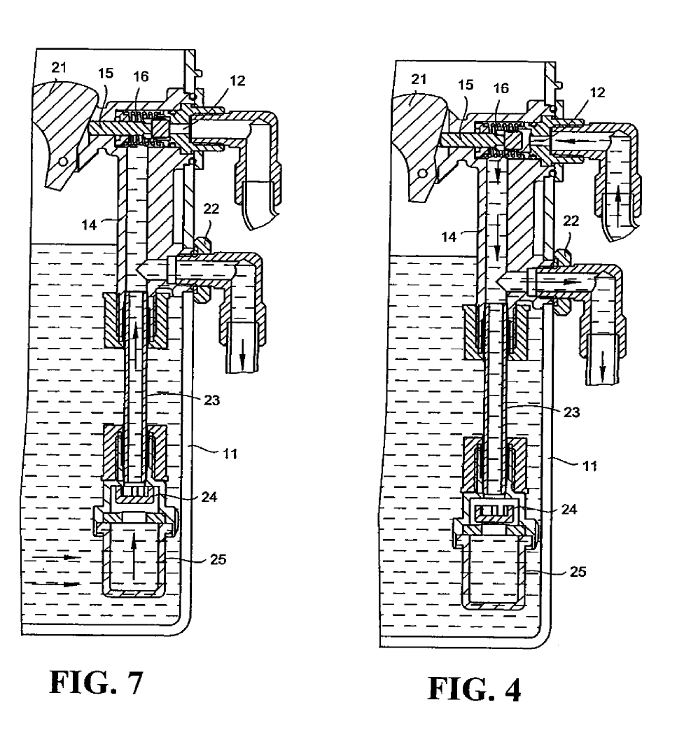

The whole switching device is directly mounted to the pump 10 without occupying a large amount of space so as to shorten and simplify piping connection. For the first time of water pressurization operation of the water pump 10, the tap water supply source is opened to directly supply tap water to the water supply port 12. At this moment, the float 20 vertically suspends at a position substantially close to and parallel to the coupling tube 14, so that the plug bar 15 is pulled inward into the container 11 and separating from the inner opening of the water supply port 12 to establish fluid communication between the water supply port 12 and the coupling tube 14, whereby the tap water flowing through the water supply port 12 is allowed to further flow through the coupling tube 14 to a pressurization chamber (not shown) of the pump 10; and the pump 10 may then be actuated to pressurize and out-feed the pressurized water, as shown in FIGS.3 and 4. When the pump 10 is turned off and the water supply is shut off, the pressurized water remaining inside the piping associated with the pump will be escorted, under the control of pressure relief means (not shown), through the water return tube 29 back into the interior of the water container 11, as shown in FIG. 5. When the water accumulation inside the water container 11 reaches a preset level, due to the upward movement of the float 10 accompanying the water level of the water accumulation, the plug bar 15 is forced toward the water supply port 12 and closes the inner opening of the water supply port 12 to shut off the supply of tap water. Under this condition, with the coupling tube 14 filled with water that is contained in the water container 11, actuation of the pump 10 for water pressurization induces suction of the water further inward the coupling tube 14 and thus causes the disk check valve 24 to move upward, thereby opening the communication between the filter can 25 and the extension pipe 23, and water is drawn through and subjected to filtration by the filter can 25 to become filtered water flowing to the pressurization chamber of the water pump 10, whereby water supply is switched to the water contained inside the water container 11, as illustrated in FIGS. 6 and 7. When the level of the water contained in the water container 11 is gradually reduced due to the water being pumped out by the water pump 10, the float 20 moves downward with the lowering water level and the plug bar 15 is driven in a direction inward into the water container 11 to thereby open the water supply port 12 by which tap water is once again supplied into the coupling tube 14. Once the supply of tap water reaches a given flow rate, the disk check valve 24 is allowed to get downward back to close the communication between the filter can 25 and the coupling tube 24, by which the water supply to the water pump 10 is completely supported by the tap water through the water supply port 12, and the operation of the water pump is subjected to no significant influence. A completely automatic switching of water inflows to the pump 10 is thus realized. Based on collection and storage of the water drained from the water pump 10 and associated piping and the control realized by the float 20 and the plug bar 15, automatic opening/closing of the supply of tap water can be done, which makes the pressurization of water and operation of the pump 10 completely sanitary and safe. This is believed to be a major breakthrough in the field of tap water supply, offering a practical, economic, and environment-friendly and sanitary reuse of water supply, especially for circulation and supply of water for pressurized spraying operation.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A float-controlled water inflow switching device adapted to use in a water pump, comprising water container in which a float for controlling water level inside the container is arranged and a water return piping system coupled to the container for receiving water released from the pump for pressure relief purposes, wherein the container is coupled to a water in-feed end of the pump and the container has a bottom forming a water return port connected to a water return tube from the pump, the container forming a water supply port in a wall of an upper portion of the container for connection with a tap water supply source and in fluid communication with interior of the container by a coupling tube, the coupling tube having a top end in fluid communication with the water supply port and movably receiving therein a plug bar that extends through a resilient element 16 that applies a force to a seal ring to seal the coupling tube against the plug bar that extends out of the coupling tube to have an end thereof coupled to an operation arm extending from the float, whereby up-and-down movement of the float causes the plug bar to do sliding motion for carrying out blocking/opening of the water supply port; wherein a water outlet port is formed in the coupling tube for connection with the water pump to provide a complete water supply loop of the pump; and wherein the coupling tube forms at a lower end thereof an extension pipe that extends to a location close to a bottom of the water container, the extension pipe comprising a disk check valve set at a lower end of the extension pipe to allow unidirectional inflow of water therethrough, whereby water accumulation inside the container causes the float to move upward, driving the plug bar to close the water supply port to shut off water supply from the water supply port so that when the pump is actuated, water supply to the pump is automatically switched to inflow suction of the water accumulated in the container and thus realizing automatic inflow switching for water supply to the pump.

2. The float-controlled water inflow switching device according to claim 1, wherein the coupling tube has a T-shaped configuration.

3. The float-controlled water inflow switching device according to claim 1, wherein the container forms in the upper portion thereof a vent hole for air ventilation.

4. The float-controlled water inflow switching device according to claim 1, wherein the water container forms in the bottom thereof a water drain port for draining water to clean the water container.

5. The float-controlled water inflow switching device according to claim 1 further comprising a filter coupled to a lower end of the extension pipe below the disk check valve.
